(19) United States
(12) Patent Application Publication
(10) Pub. No.: US 2009/0204517 A1
(43) Pub. Date: Aug. 13, 2009

(54) INTERCOMPANY ACCOUNTING DATA ANALYTICS

(76) Inventors: Corey D. Edens, Scottsdale, AZ (US); John D. Brandt, Portland, OR (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/030,803

(22) Filed: Feb. 13, 2008

(51) Int. Cl. G06Q 10/00

(52) U.S. Cl. 705/30

(57) ABSTRACT

Methods and apparatuses enable finding and resolving intercompany (I/C) transaction issues in accounting data for a corporate enterprise. A data management tool receives general ledger data that defines intercompany account balances for multiple business entities of the corporate enterprise. The data management tool identifies a trading relationship and a currency relationship between two business entities of the corporate enterprise. The data management tool groups account balances based on the identified trading relationship and currency relationship. The data management tool generates one or more reports or indicators that indicate the grouped account balances.

### FIELD

Embodiments of the invention relate to data aggregation, analysis and management, and more particularly to accounting data management tools that provide an analytic framework to assess intercompany accounting data in transaction currency from a single or multiple accounting/ERP (enterprise resource planning) systems and that provide requisite reporting to furnish assurance that intercompany balances are properly stated and in balance in transaction currency across the enterprise.

### BACKGROUND

Companies record business transactions in their accounting system each and every day, including the sale of their product, a purchase of materials or services, and the recording of transactions between the separate entities that make up the enterprise (intercompany (I/C) transactions). I/C transactions typically result from the cross-charging of product, services, and/or other business transactions between these entities.

As companies grow and expand, the complexity of their corporate structure increases. The expansion of the business frequently results in a parent company that has multiple subsidiaries. It is not uncommon for the parent company and the subsidiaries to be organized and operated as separate business entities, each entity considered separate for accounting purposes. For purposes of clarity herein, and not by way of limitation, the collection of business entities will be referred to as a corporate enterprise, and each entity will be referred to as a business entity, or simply entity.

Depending on how growth of the company has occurred (e.g., organically versus merger/acquisitions), many times companies are faced with having many entities spanning a number of accounting/ERP systems. Each accounting/ERP system may have its own chart of accounts and associated methodology for how intercompany accounts are maintained within the charts of accounts (e.g., specific intercompany account for each entity, specific intercompany account for each entity relationship, or common intercompany account with a trading partner/affiliate associated with it).

An I/C transaction is a business transaction between two entities within the corporate enterprise. The business transaction results in a payable or receivable in the books of one entity, and an equal but opposite receivable or payable in the books of the other entity. As a general rule and control point, the I/C balances recorded in the two entities that make up the I/C relationship should at all times be equal and offsetting. Said another way, the I/C balances recorded in the two entities should net to zero within the same transaction currency (i.e., the I/C receivable from entity 200 in the books of entity 100 should equal the I/C payable to entity 100 as recorded in the books of entity 200).

As companies grow in size and complexity, the recording of business transactions becomes more decentralized and accounting controls around the recording of transactions becomes more difficult to monitor. An underlying multicurrency accounting premise is that transactions are timely recorded in the transaction currency of the business transaction. Breakdowns in the area of recording I/C transactions can result in I/C account balances that are out of balance across the enterprise. Such breakdowns can be caused by actions such as: 1) one entity recording the receivable or payable, while the other entity has neglected to record the transaction, or inaccurately recorded the transaction; and, 2) each entity to the I/C transaction has recorded the transaction in the local currency of the entity instead of the currency of the business transaction (e.g., a Canadian entity converting a USD (U.S. dollar) I/C invoice to CAD (Canadian dollar) prior to recording the entry in the accounting system). Each of these accounting errors will cause the I/C relationship between the two entities that are part of the relationship to be out of balance. Out of balance situations can result in accounting and operational inefficiencies to reconcile the accounts and settle intercompany balances. Furthermore, out of balance situations can result in ineffective foreign currency risk management as I/C balances representing currency exposure are misstated.

Effective I/C accounting is based on the ability of enterprises to reconcile, test, and assure themselves that the I/C accounts are in balance at the transaction currency level. Depending on the size and complexity of the enterprise, the I/C accounting data necessary to perform the testing and reconciliation can reside within one or many source accounting/ERP systems. Currently there are no tools available to effectively provide enterprises with the ability to aggregate transaction currency I/C accounting data for a given date from a number of accounting systems. Without such an ability, enterprises may lack visibility and transparency into the complete set of I/C accounting records, which prevents effective data analysis at various levels focused on testing the validity of I/C data relationships, as well as reporting to efficiently and effectively resolve underlying data issues. Today enterprises do not have the tools available to provide the visibility, analysis, and reporting necessary to: 1) effectively furnish assurance that I/C balances are properly stated and in balance in transaction currency across the enterprise; or, 2) efficiently resolve underlying data issues.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an embodiment of a system with an I/C analyzer connected to a data filtering module.

FIG. 2 is a block diagram of an embodiment of an I/C analyzer that generates one or more reports for intercompany data analysis.

FIG. 3 is a block diagram of an embodiment of a system with an I/C analyzer that receives data from distinct ERP systems.

FIG. 4 is a block diagram of an embodiment of an I/C analyzer.

FIGS. 5A-5B illustrates an embodiment of example data used to group account balances by an I/C analyzer.

FIG. 5C is a block diagram of an embodiment of account and entity relationships.

FIG. 6 illustrates an embodiment of example output data as provided by an I/C analyzer to group account balances based on entity and currency relationships.

FIG. 7 illustrates an embodiment of example output data as provided by an I/C analyzer to group account balances based on entity, currency, and account relationships.

FIG. 8 is a flow diagram of an embodiment of a process for intercompany analysis of accounting data.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DETAILED DESCRIPTION

As provided herein, data management tools enable finding and resolving intercompany (I/C) transaction issues in accounting data for a corporate enterprise. A data management tool receives general ledger data that defines intercompany account balances for multiple business entities of the corporate enterprise. The general ledger data may come from one or multiple accounting systems. Thus, the data management tools as described herein enable data management for single or multisystem accounting data issues. The data management tool identifies a trading relationship and a currency relationship between two business entities of the corporate enterprise. The data management tool groups account balances based on the identified trading relationship and currency relationship. In certain embodiments, other relationships can be identified, as described in more detail below, and the account balances grouped in accordance with such other relationships. The data management tool reports on the grouped account balances. In one embodiment, a report flags certain balances or transactions.

In one embodiment, the analysis of I/C transactions within the accounting data is founded upon three fundamental premises: 1) I/C transactions must have offsetting entries; 2) I/C transactions between entities should net to zero for any and all currencies; and, 3) transactions should be cleared in their transaction currency. These three assumptions can be designed into the data management tools provided herein to provide an I/C transaction analysis based on these assumptions. An analysis based on these assumptions will tend to find and indicate inconsistencies in I/C accounting.

In one embodiment, the data management tool creates one or more unique identifiers to identify the currency relationship, the entity relationship between the two business entities, and/or other relationships for the account balances. With the unique identifier(s), the data management tool can search the received accounting data for account balances that match the elements of a unique identifier. There are at least two ways to create a unique identifier. In one embodiment, the data management tool generates a unique identifier by identifying a trading relationship from the accounting data, determines whether a unique identifier exists for that trading relationship, and generates a unique identifier if one does not already exist. In another embodiment, the data management tool generates all possible unique identifiers based on all combinations of trading relationships and currency relationships. Additional unique identifiers can be created selectively (e.g., user-selected, or user-defined preferences) for other relationships. Such information to create the unique identifiers can be extracted from the accounting data and referencing configuration settings. When the data management tool processes the accounting data and groups the account balances, it can access an account balance and then create a mapping between the account balance and an accompanying unique identifier. All mapped data can then be grouped to complete the processing.

Note that the unique identifiers are based on I/C transactions. The business entities within the corporate enterprise may be hierarchically organized. Either a hierarchy will exist as established by the corporate enterprise itself, or the data management tool can create a hierarchy for purposes of analysis. In one embodiment, the unique identifiers are ordered based on the hierarchical ordering of business entities. In another embodiment the unique identifiers are ordered based on sorting the entity identifiers.

The data management tool can identify in its reports out-of-balance (OOB) or potentially OOB situations and/or potential error conditions within the accounting data. Flagging the data that poses a potential OOB situation or error condition enables a user to examine the related transactions in closer detail to determine whether the imbalance is expected, or indicative of an error. Thus, the data management tool provides means to enable a user to identify problems or potential problems associated with I/C transaction accounting. The OOB situations or error condition may include: using a third currency in the transaction, having a trading relationship where the same business entity exists on both sides of the trading relationship, an uneven number of records for the transactions, or a non-zero balance for a currency.

In one embodiment, the data management tools can provide graphical representations of data including trading relationships (entity and/or currency). Such graphical representations may include graphs, pie charts, tables, etc., and may display metrics, benchmarks, etc. In one embodiment, the data management tool generates links within the reports to the underlying data to enable a user to access the data from within the report. Thus, indications of inconsistency or potential OOB situations can be examined by drilling down into the underlying accounting data.

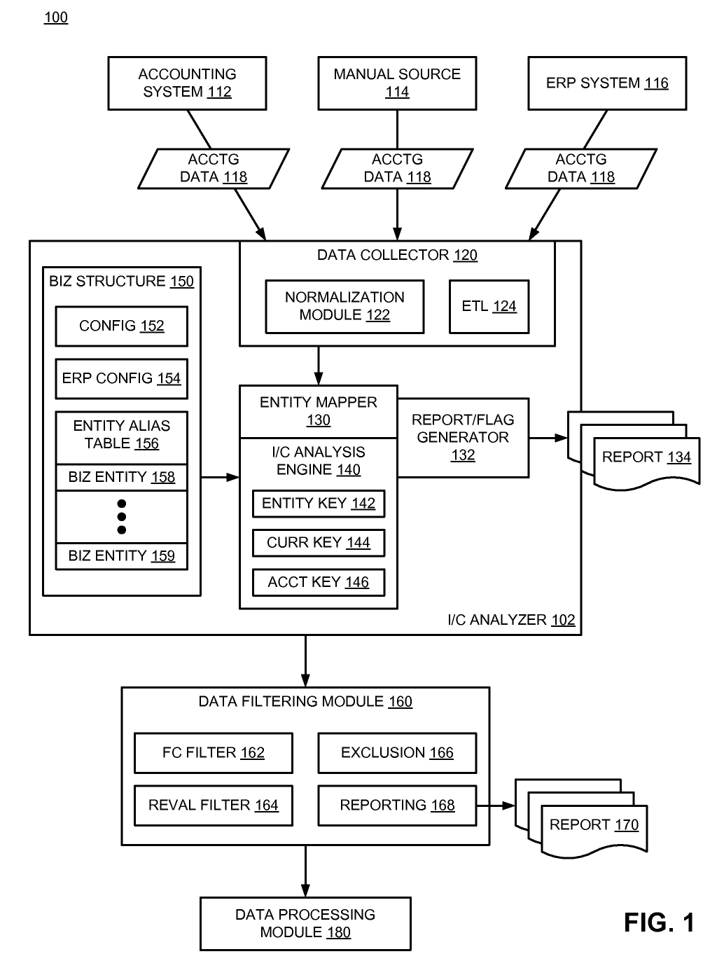

FIG. 1 is a block diagram of an embodiment of a system with an I/C analyzer connected to a data filtering module. System 100 represents a data management system, which will receive input accounting data, and output data for further analysis or action. System 100 includes one or more sources of accounting data or general ledger data. A single accounting system or ERP system can provide multiple separate sources of data. For purposes of simplicity, the data received from the accounting systems will be referred to as “accounting data,” which will refer to general ledger data, or data that would be recorded/reported on a company's general ledger. A simple version of a system may include a single data source. Other systems may include multiple sources, which could consist of one or more of some or all of the types of sources depicted in FIG. 1. As shown, source types may include accounting system 112, manual source 114, and enterprise resource planning (ERP) system 116. Manual source 114 refers to any type of document that is generated by manual input and accounting of data. ERP system 116 refers generally to any type of enterprise system (e.g., such as systems available from SAP AG of Walldorf, Germany, systems available from ORACLE CORPORATION of Redwood Shores, Calif., etc.). Accounting system 112 is intended to represent any other type of accounting system or data management software that does not fall under the category of a manual process or an ERP system.

Each of data sources 112-116 provides accounting (acctg) data 118 to I/C analyzer 102. Accounting data 118 represents data defining asset and liability account balances for a company. Within accounting data 118 is data defining intercompany (I/C) transactions or I/C account balances. I/C analyzer 102 represents one or more tools with which accounting data 118 is analyzed. The various blocks can each be considered separate tools, in which case I/C analyzer 102 represents a “toolbox” of analysis/processing modules. Alternatively, I/C analyzer 102 can be considered an analysis tool with various functional blocks. Other functional blocks could be added to I/C analyzer 102. Not all functional blocks shown are necessary for an implementation of the inventive concepts described herein.

I/C analyzer 102 includes data collector 120, which represents one or more data gathering modules. Data collector 120 enables I/C analyzer 102 to receive accounting data 118. In one embodiment, data collector 120 includes normalization module 122 to normalize the received accounting data. Normalizing the data refers to one or more operations performed on the data to produce a data set complying with certain conditions. That is, the data received/extracted may not have the same format if received from different systems, until normalized. Normalizing the data can include extracting data from a source and storing it into a results data set. Normalizing could alternatively refer to making modifications to the received data. Normalizing could be accomplished by having operations to search for desired data, which can be extracted from received data and organized in a desired manner. In one embodiment, data collector 120 includes ETL 124, which refers to an extract, transform, and load mechanism that pulls data and normalizes it. ETL 124 could be part of normalization module 122, or could be the normalization module of data collector 120. Note that not all data need be normalized. Data could be provided from one or more source systems directly into I/C analyzer 102 with normalization operations already performed on the data.

In one embodiment, data collector 120 associates certain elements of data with other elements of data. For example, data belonging to the same account can be grouped together, as can data belonging to the same business entity, etc. Data may be associated via date ranges, such as specifying an effective date of data to obtain. In general, data collector 120 will be understood to obtain “all” asset and liability account balances. In one embodiment, receiving or obtaining “all” data may refer to all data belonging to an effective date range. Thus, “all” data may refer to data of whatever business entity, and whatever account, for example, but may exclude some data from systems 112-116.

I/C analyzer 102 may include entity mapper 130, which represents a module that can map entity aliases across the accounting/ERP systems back to a particular base business entity. That is, business entities may be referenced by different designations within the different systems. Part of a data normalization process may include associating all data related to a particular business entity, and identifying the business entity to which the data is related.

I/C analyzer 102 includes I/C analysis engine 140, which enables I/C analyzer 102 to provide the I/C analysis as described herein. In one embodiment, I/C analysis engine 140 and entity mapper 130 are the same, or are part of the same functional module. Other example embodiments of an I/C analyzer are described in more detail below. I/C analysis engine 140 represents any embodiment of an I/C analyzer as described herein. In general, I/C analysis engine 140 performs an analysis of received accounting data to determine if the I/C transactions are reported in a way that will result in consistent results in all data and financial analyses. In one embodiment, I/C analysis engine 140 tests the three assumptions listed above. That is, I/C analysis engine 140 determines whether I/C transactions have offsetting entries, whether the transactions net to zero for any and all currencies, and whether the transactions are cleared in their transaction currency.

In one embodiment, I/C analyzer 102 includes a description of the business relationships of the parent company and its subsidiaries, as depicted with business (biz) structure 150. Business structure 150 identifies configuration 152 associated with the corporate enterprise, which may indicate entity structure of the corporate enterprise, as further defined by entity alias table 156, which lists all of its business entities 158-159. Business structure 150 includes ERP configuration 154, which may indicate accounting conventions for data received from the one or more accounting systems. In one embodiment, business structure 150 indicates a hierarchy of the business entities, which may be used by I/C analysis engine 140 to generate unique identifiers or keys with which to analyze the accounting data.

Report/flag generator 132 is a report module that may be part of entity mapper 130 and/or I/C analysis engine 140. Report/flag generator 132 enables I/C analyzer 102 to indicate account balances where potential OOB or other error conditions exist, and/or generate reports that indicate potential OOB or other error conditions with accounting data 118. In one embodiment, I/C analysis engine 140 generates links to the received/extracted data obtained by data collector 120, and links the reports or flags to the actual data that is determined to have a potential OOB or other error condition. All such reports and links can be provided in report(s) 134 as generated by report/flag generator 132.

In one embodiment, I/C analysis engine 140 includes entity key generator 142, currency key generator 144, and account key generator 146. The various keys are used to filter and group account balances from the accounting data based on relationships in entity (e.g., trading relationships), currency, and potentially an account balance relationship. Account balance relationships can include any of a number of relationships, including those based on legal entity, account, and/or system. As used herein, a legal entity or trading relationship refers to any type of account balance relationship based on the legal entities indicated in the account balances, and may include but are not limited to, for example, accounts related according to business unit, region (e.g., geographic location), project code (e.g., an identifier for a specific project to which a transaction is related), profit center designation (e.g., the account balance is associated with a profit center entity), etc. As used herein, an account relationship refers to any type of account balance relationship based on commonality with accounts, and may include but are not limited to, for example, accounts related according to project code, account number, subaccount number, cost center designation (e.g., the account balance is associated with an entity designated as a cost center), etc. As used herein, a system relationship refers to any type of account balance relationship based on a system associated with the account balance, and may include but are not limited to, for example, accounts related according to data source (e.g., an accounting system, or source within an accounting system), user (e.g., who entered the account balance, who is in charge of the account balance), etc.

In one embodiment, system 100 includes data filtering module 160 coupled to I/C analyzer 102. Data filtering module 160 includes one or more filters or processing modules with which to process accounting data 118. In one embodiment, I/C analyzer 102 and data filtering module 160 work in combination as a suite of data management tools to provide information related to multiple aspects of accounting data 118. In one embodiment, after I/C analyzer 102 provides I/C transaction analysis information, the data is passed to data filter module 160 to specifically processes data for foreign exchange (F/X) risk analysis/management. Data filtering module 160 may include functional currency (FC) filter 162, revaluation (reval) filter 164, exclusion filter 166, and reporting module 168.

FC filter 162 provides an analysis of whether the functional currency of a transaction is equal to the transaction currency (TC). That is, FC filter 162 eliminates account balances where the FC is equal to the TC. Account balances where FC=TC do not generate F/X risk, since there is no risk associated with currency exchange rate movements. Thus, FC filter 162 reduces the received data set to account balances where the FC and the TC are different, and thus may be subject to F/X risk given exchange rate movements.

Revaluation filter 164 further filters the received data set to generate a data set of account balances that further are subject to revaluation. In terms understood by those familiar with the art, revaluation filter 164 filters account balances based on whether the account balances are outside FAS52. As used herein, FAS refers to the United States Federal Financial Accounting Standards (FAS), where FAS52 refers to Statement 52 of the accounting standards dealing with accounts that should be revalued. Generally, accounts that are not subject to revaluation can be excluded from F/X risk analysis. Thus, revaluation filter 164 can remove account balances not subject to revaluation. Note that revaluation filter 164 may not provide a complete FAS52 analysis. Note that FC filter 162 and revaluation filter 164 are not required to be applied in any particular order. Rather, these blocks can be swapped in terms of order of analysis of accounting data 118.

Exclusion filter 166 may exclude from the data set particular data, which can be identified, for example, by specific account number, account range, currency, entity, etc. Exclusion filter 166 enables data filtering module 160 to exclude from analysis, for example, data with known issues, or data that is known to need special handling. Account balances removed by exclusion filter 166 have special issues to be handled by the controller of the business entity (or its parent) for which analysis is being performed. The application of exclusion filter 166 can prevent “known” errors or issues from being passed to a decision-making stage or a risk assessment/management stage of analysis.

Reporting module 168 represents one or more report generators. The elements of data filtering module 160 may generate one or more reports to indicate results or exceptions of processing of received data. Reporting module 168 generates one or more reports 170, which may include text output, graphical output, tables, or other form of data output.

In one embodiment, data filtering module 160 may include another functional block (not shown), or may pass its resulting data set to another functional block. Such a functional block may operate to groom a resulting data set to a particular formatting or standard layout. For example, the processed data may be input into data processing module 180 for additional processing. Data processing module 180 can be, for example, a system for F/X management as described in co-pending U.S. patent application Ser. No. TBD, entitled, “Method and System for Identifying and Managing Currency Exposure,” filed Jun. 6, 2007, and/or co-pending U.S. patent application Ser. No. 11/833,172, entitled, “Forecasted Currency Exposure Management,” filed Aug. 2, 2007. There may be a particular data format that will be useful for providing to data processing module 180, which can be provided by data filtering module 160, or some other grooming block.

Various operations or functions are described herein, which may be described or defined as software code, instructions, configuration, and/or data. The content may be directly executable (“object” or “executable” form), source code, or difference code (“delta” or “patch” code). The software content of the embodiments described herein may be provided via an article of manufacture with the content stored thereon, or via a method of operating a communication interface to send data via the communication interface. A machine readable medium may cause a machine to perform the functions or operations described, and includes any mechanism that provides (i.e., stores and/or transmits) information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein may be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

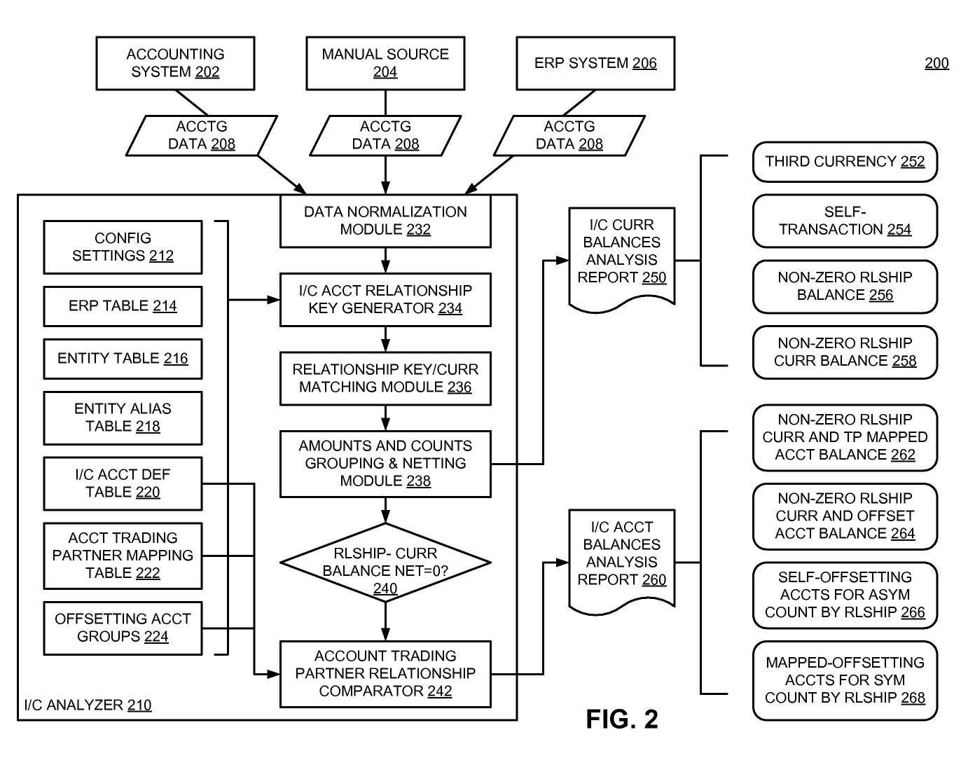

FIG. 2 is a block diagram of an embodiment of an I/C analyzer that generates one or more reports for accounting data analysis. System 200 provides one example of a data management tool focused on I/C transaction analysis. System 200 includes one or more data sources, accounting system 202, manual source 204, and ERP system 206, representing one or more systems. Each data source corresponds to the discussion of similar components described in FIG. 1. The data sources generate accounting data 208, which is passed to I/C analyzer 210. I/C analyzer 210 provides an example of an I/C analyzing mechanism according to any embodiment described herein.

In one embodiment, I/C analyzer 210 receives accounting data 208 at data normalization module 232, which normalizes the accounting data, as described above. Data normalization module 232 passes the normalized accounting data to I/C account (account) relationship key generator 234 (hereafter “generator 234”), which generates one or more keys related to account balance relationships, as described above.

Account balance relationships can be identified and generated with various data stored in I/C analyzer 210, stored elsewhere and available to I/C analyzer 210, or derivable from accounting data 208 (e.g., the information can be extracted by processing accounting data 208 to extract the information. Configuration settings 212 represent any of a number of corporate and ERP configuration settings. The configuration settings indicate how to interpret the data, which enables I/C analyzer 210 to process the data and extract the information desired for I/C analysis.

ERP table 214 references a chart of accounts within an accounting/ERP system. Entity table 216 indicates the entities that are resident within each of the accounting/ERP systems. Entity alias table 218 provides information that enables a mapping of one entity to another across different ERPs or accounting systems (e.g., entity 205 of system 1 corresponds to entity 15A of system 2). Entity alias table 218 could be said to provide entity identifier “synonyms” to map entities from one system to another. I/C account definition (acct def) table 220 defines how I/C accounts are defined and used within a system. Account trading partner mapping table 222 defines relationships between accounts and trading partners within accounting data 208. Offsetting account groups 224 define what accounts represent I/C account groups that should net to zero.

I/C analyzer 210 includes relationship key/currency matching module 236 (hereafter “module 236”). Module 236 matches keys of one type to keys of another type. Thus, generator 234 generates keys or unique identifiers of various types according to relationships identified within accounting data 208, and module 236 maps keys or unique identifiers of one type to keys or unique identifiers of another type. Thus, a trading relationship (e.g., trading partners) may exist between entities 205 and 255, which may correspond to one or more currency relationships (e.g., USD and CAD) between the entities. Additionally, one or more account relationships can be associated with the various keys, such as account offset groups.

Accounts and counts grouping and netting module 238 (hereafter “module 238”) groups the data based on account balances, according to the keys generated and matched. When the accounts are grouped, in one embodiment, module 238 counts or calculates the numbers of accounts that are netted or that correspond to a single account balance. In one embodiment, I/C analyzer 210 generates one or more I/C currency balances analysis reports 250 (hereafter “reports 250”) based on the information processed up through module 238.

Reports 250 may include, but are not limited to, third currency report 252, self transaction report 254, non-zero relationship (rlship) balance report 256, and non-zero relationship currency balance report 258. Third currency report 252 indicates whether there are third currency relationships. A “third currency” is a currency in which a transaction is conducted between two trading partners that is not the functional currency of either of the entities (e.g., a U.S. entity and a Canadian entity transacting in Japanese Yen—where yen is the third currency). Self-transaction report 254 can indicate whether an entity has account balances that indicate that the entity is “trading” with itself (e.g., listed a receivable and payable for goods transferred from one department to another within the same entity). Report 256 indicates when related accounts that should net to zero do not net to zero (and identifies the accounts). Report 258 indicates when accounts related by currency relationship do not net to zero.

I/C analyzer 210 includes determination module 240 that determines if relationship and currency balances net to zero. Determination module 240 passes processed data to account trading partner relationship comparator 242 (hereafter “comparator 242”). Comparator 242 may access I/C account definition table 220, account trading partner mapping table 222, and/or offsetting account groups 224 to generate reports related to data having to do with the trading partner relationships. After processing by comparator 242, I/C analyzer 210 generates one or more I/C account balances analysis reports 260 (hereafter “reports 260”).

Reports 260 may include, but are not limited to, non-zero relationship currency and trading partner (TP) mapped account balance report 262, non-zero relationship currency and offset account balance report 264, self-offsetting accounts for asymmetric (asym) count by relationship report 266, and mapped-offsetting accounts for symmetric (sym) count by relationship report 268. Report 262 indicates when a relationship for a particular currency, trading partners, and an account balance does not net to zero when the account balance should net to zero. Report 264 indicates when a relationship for a currency and offset account balance does not net to zero when the account balance should net to zero. Report 266 indicates when self-offsetting accounts (e.g., accounts set up or designated within the accounting system as offsetting accounts) do not have an even record count. An uneven record count indicates that certain postings were missed in the books of one entity or the other. Similarly, report 268 indicates uneven record counts for accounts that are set up by the I/C analyzer system to be offsetting, even if such accounts are not inherently set up to be offsetting within the accounting system(s).

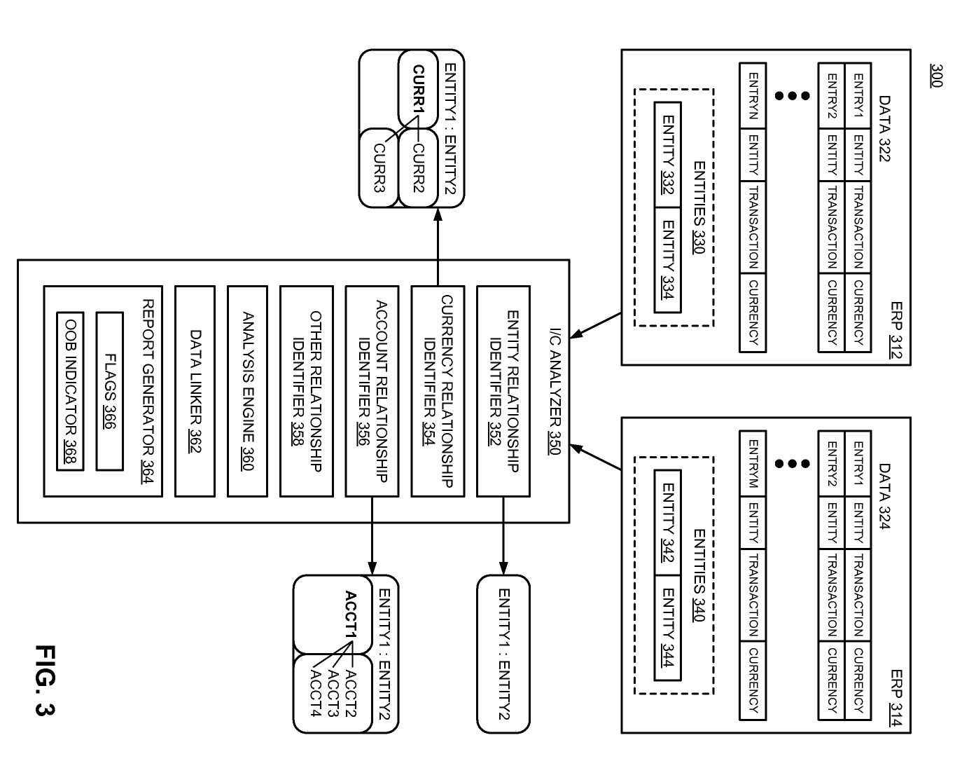

FIG. 3 is a block diagram of an embodiment of a system with an I/C analyzer that receives data from distinct ERP systems. System 300 provides a simplified example of certain elements that are found in system 100 of FIG. 1. System 300 includes ERP 312 and ERP 314, which are distinct ERP systems. For example, ERPs 312 and 314 may be any combination of an accounting/ERP system (e.g. SAP ERP system, an ORACLE ERP system, a PEOPLESOFT ERP system, or a JD EDWARDS ERP system). Note that all trademarks used herein are used solely for purposes of identification, and all marks are the property of their respective owners. The PEOPLESOFT and JDEWARDS systems are available from ORACLE CORPORATION. The teachings herein with reference to I/C analysis are applicable to corporate configurations using one or more different accounting/ERP systems. Note that many companies attempt to “solve” I/C accounting inconsistencies by migrating to a single ERP system. However, it is the experience of the inventors that migration to a single ERP system does not eliminate I/C accounting inconsistencies, and it certainly does not provide tools to identify and generate a report of the I/C accounting issues present in transaction currency accounting data.

ERP 312 is illustrated with data 322, which represents account balances for transactions made by one or more business entities. The data may be organized in any manner imaginable, and generally will indicate entities involved in the transaction, a description of the transaction, the amount of the transaction, and a currency in which the transaction took place. Note that as shown, each entry includes entity, transaction, and currency. Transaction as used in ERPs 312 and 314 is a generic representation of all other data besides entity and currency that is part of the posted transactions (e.g., account numbers, amounts, dates, etc.). The actual data may or may not indicate the entry number, but is included herein for illustrative purposes. ERP 312 also includes entities 330, which may or may not be explicitly be provided in ERP 312. That is, ERP 312 may include a table or data store of entities, which indicates what entities (such as entities 332 and 334 listed in FIG. 3) have associated data entries. Alternatively, data 322 may simply have transaction information that indicates the entity to which the transaction is related. Thus, entity information must be extracted from the account balance data. The same is true of ERP 314 with data 324 and entities 340.

For purposes of the discussion of FIG. 3, a common scenario will be assumed. Both ERP 312 and ERP 314 have account balances related to transactions by a single business entity, but the two ERP systems refer to the business entity with different entity indicators (or identifiers). That is, consider that entity 332 of ERP 312 corresponds to entity 344 of ERP 314. Thus, the same business entity is referred to by different identifiers. In such an embodiment, the data analysis for purposes of I/C transaction analysis should normalize the data to be able to indicate across ERP systems what transactions are related to a particular business entity. I/C analyzer 350 may generate a mapping of business entities within entity relationship identifier 352 to be able to identify all account balances related to a single business entity, even across ERP systems.

I/C analyzer 350 provides one example of an I/C analyzer according to any embodiment described herein. I/C analyzer 350 includes various functional blocks, as depicted by entity relationship identifier 352, currency relationship identifier 354, account relationship identifier 356, other relationship identifier 358, analysis engine 360, data linker 362, and report generator 364.

Entity relationship identifier 352 enables I/C analyzer 350 to identify entity relationships in transaction data. The entity relationship may also be referred to as a trading relationship. Similarly, currency relationship identifier 354 enables I/C analyzer 350 to identify currency relationships in transaction data, including third currency relationships, when they exist. The entity relationship and a currency relationship together act as a unique identifier or a key for organizing data for I/C transaction analysis. The entity relationship can be identified by determining the transacting parties of a transaction. The currency of the transaction will be indicated in the transaction. The currency of the transaction can be compared with the currencies known for each entity to determine what currency relationship exists for the transacting parties.

FIG. 3 illustrates an entity relationship as entity1:entity2. Note that the designation of the entities need not be the same in the entity relationship as is found in either ERP system. That is, I/C analyzer 350 may designate entities in one way (e.g., by name) that is different than the designation (e.g., an entity ID number) found in either ERP system. The entity relationship can be understood generically as any two entities that are transacting. For a given entity relationship, there may be a single currency relationship, or multiple currency relationships possible. Multiple currency relationships can also occur in the case of third currency transactions. A third currency transaction occurs when a transaction is accounted for in a currency that is not the functional currency of either entity (e.g., a USD entity transacting with a GBP entity in EUR).

Similar to entity and currency relationship identifiers, account relationship identifier 356 and other relationship identifier 358 provide keys for organizing data for I/C transaction analysis. Account relationship identifier 358 indicates account relationships (e.g., a relationship between account 1 and one or more other accounts 2-4). Other relationships can similarly identify further relationships in the data. Note that in one embodiment, account relationships and other relationships are identified for particular entity and currency relationships. Thus, an account relationship key is valid for data identified by an entity-currency relationship key.

Analysis engine 360 enables I/C analyzer 350 to analyze the accounting data from the ERP systems in accordance with the entity and currency relationships. The data is grouped in accordance with the unique identifiers to be able to determine if all transactions have counterpart transactions, and whether the sum of all transactions is zero. The data can simply be searched by the two entities, each one in turn, and then the currencies, in turn.

Data linker 362 enables I/C analyzer 350 to provide links to gathered data. Note that data will be received or accessed and a copy will exist at the I/C analyzer. It is that copy that is processed and analyzed. That same data can also be linked to enable a user to look back to the data that caused an exception or a potential OOB or other condition flag to be generated. The links can implemented, for example, as interactive memory pointers, hyperlinks in the data or references to data sources.

Report generator 364 enables I/C analyzer 350 to generate reports to indicate what the data looks like after processing, and what errors or exceptions may have occurred during processing. Report generator 364 may include flags 366, which represents the different scenarios types that might be encountered in data processing and would therefore cause a flag to be generated. Examples would include intercompany transactions denominated in a third currency or a situation where the intercompany entity trading relationship is with itself. OOB indicator 368 represents certain rules or conditions that can be tested for to indicate whether a potential or actual out-of-balance situation is encountered (e.g., an odd number of records exists for a particular currency). Note that in one embodiment, flags 366 and OOB indicator 368 could be considered to be the same thing.

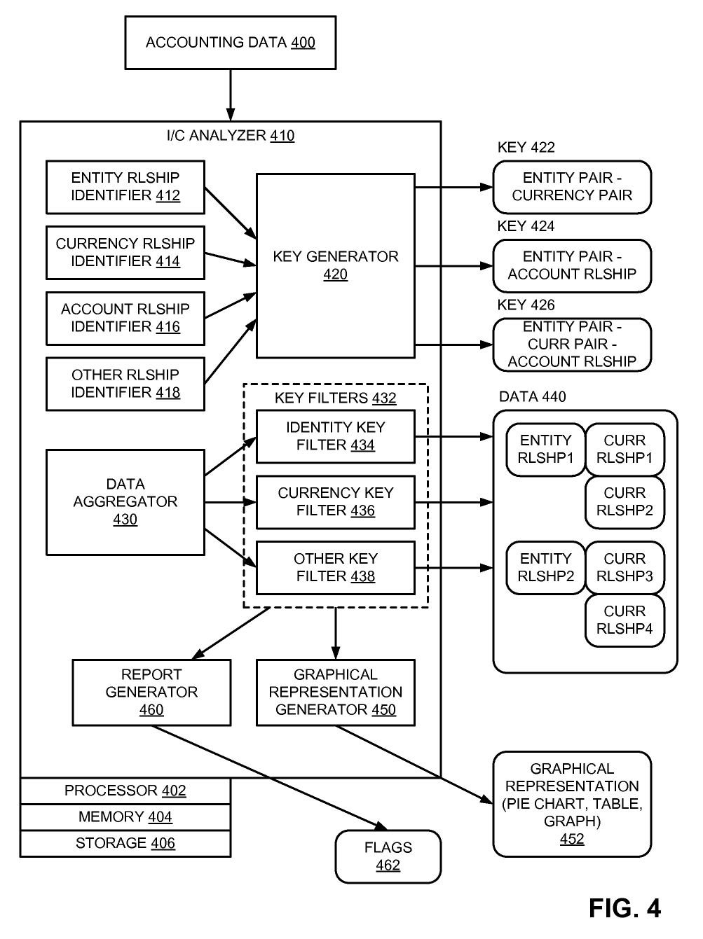

FIG. 4 is a block diagram of an embodiment of an I/C analyzer with a generic form factor of data output. General ledger (G/L) or accounting data 400 is retrieved by I/C analyzer 410 (which may include having data uploaded to a data workbench that includes I/C analyzer 410). I/C analyzer 410 processes the data and/or accesses other data with entity relationship identifier 412 to identify entity relationships. Similarly, I/C analyzer 410 invokes currency relationship identifier 414 to identify currency relationship(s) for the entity relationships. I/C analyzer 410 can also invoke account relationship identifier 416 and other relationship identifier 418 to identify relationships within accounting data that may determine how data is grouped and what information is provided in reports. Key generator 420 receives information related to entity relationships, currency relationships, account relationships, and any other relationships to generate one or more keys to group the data. As suggested previously, key generator 420 may generate keys on the fly as data is processed, or key generator 420 may generate all keys, and then match data to keys. Key 422 represents a key, and has an entity pair (an entity relationship) and a currency pair (the currencies involved in a transaction between the entities). There should be multiple records for each key, because there should be at least two entries (an entry such as a 600,000 payable, and a counter entry such as a corresponding 600,000 receivable). Other example key types are shown as key 424, which represents a key that has an entity pair and an account relationship, and key 426, which represents a key that has an entity pair, a currency pair, and an account relationship.

I/C analyzer 410 includes data aggregator 430, which represents one or more functional elements that group the data based upon keys 422, 424, and/or 426. The grouping and organizing of data enables an output that provides useful information to a user. For example, data aggregator 430 invokes one or more key filters 432 to organize data according to the relationship associated with the key. Identity filter 434 enables organizing the data by entity or entity relationship. Data aggregator 430 invokes currency filter 436 to further group the data based on currency for each grouping of entities. Data aggregator 430 can further invoke other key filter 438 to group the data based on other relationships (e.g., account). Data 440 provides a generic example, where entity relationship 1 is shown with data related to currency relationship 1 and currency relationship 2 for entity relationship 1. Similarly, entity relationship 2 has data grouped for currency relationship 3 and currency relationship 4. Note that currency relationships 3 and 4 could be the same currency relationship as 1 or 2, just with a different entity relationship. An example of an account relationship is not illustrated here, but is provided in more detail below.

Either to produce the layout of data 440, or for an alternative data representation layout, I/C analyzer 410 may provide output data to graphical representation generator 450 to generate graphical representation 452. Graphical representation 452 may be a table (similar to data 440), a pie chart, a graphic, etc. Additionally, I/C analyzer 410 can process the data in accordance with exception condition rules and determine if there are any exception conditions to report. Report generator 460 can generate one or more flags 462, as appropriate. In one embodiment, only flagged data is linked. In another embodiment, some or all data is linked, regardless of whether the data generates a potential OOB or other error condition and/or a flag.

FIG. 4 also represents various hardware resources, namely, processor 402, memory 404, and storage 406. Processor 402 represents one or more processors, which may be discrete devices, multi-core processors, central processing units (CPUs), microprocessors, microcontrollers, etc. Processor 402 enables I/C analyzer 410 to perform processing/analysis. Storage 406 provides non-volatile storage of data and instructions. Memory 404 represents any type of memory that provides temporary storage of data and instructions. Memory 404 may include any type of random access memory (RAM), as well as read-only memory (ROM), or Flash. Thus, memory 404 may be a volatile or non-volatile memory device (i.e., it may or may not lose state when power is interrupted to the memory device). In certain computing devices, memory 404 and storage 406 may be the same device, or partitions of the same device. In one embodiment, processor 402, memory 404, and storage 406 are resources associated with a server. Accounting data is received over a network at a server, which provides the I/C data analysis services described. Such a server can include a hosted ASP environment, such as an application environment hosted via services over a network (such as the Internet). I/C analyzer 410 could thus be executed in a server and receive input data from a company or organization to perform analysis. Alternatively, I/C analyzer could be executed locally to the organization or company for which accounting data 400 is provided.

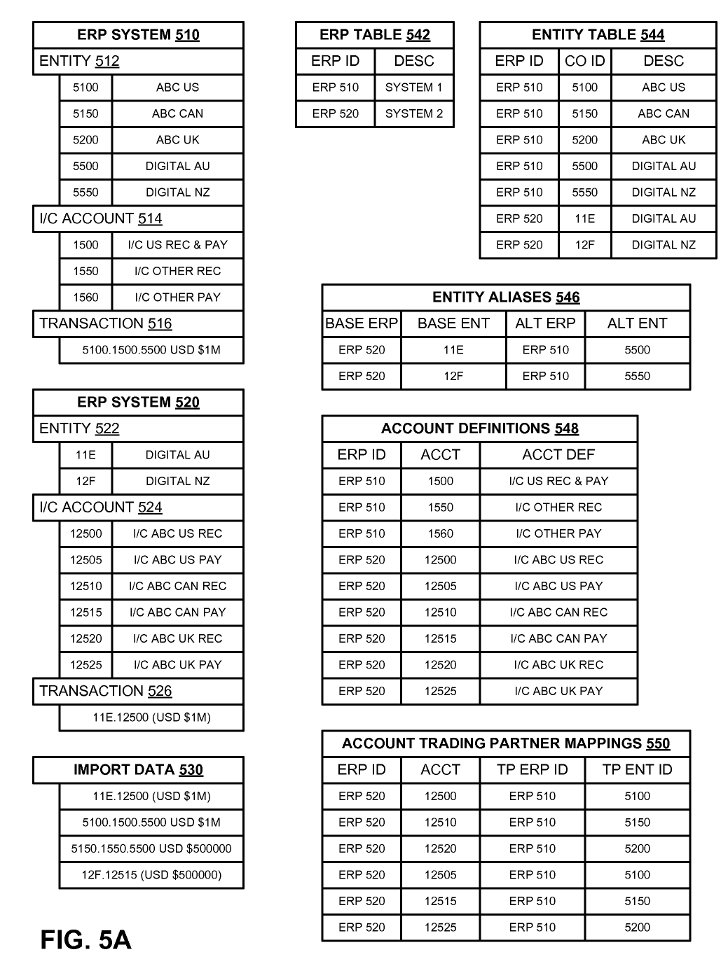

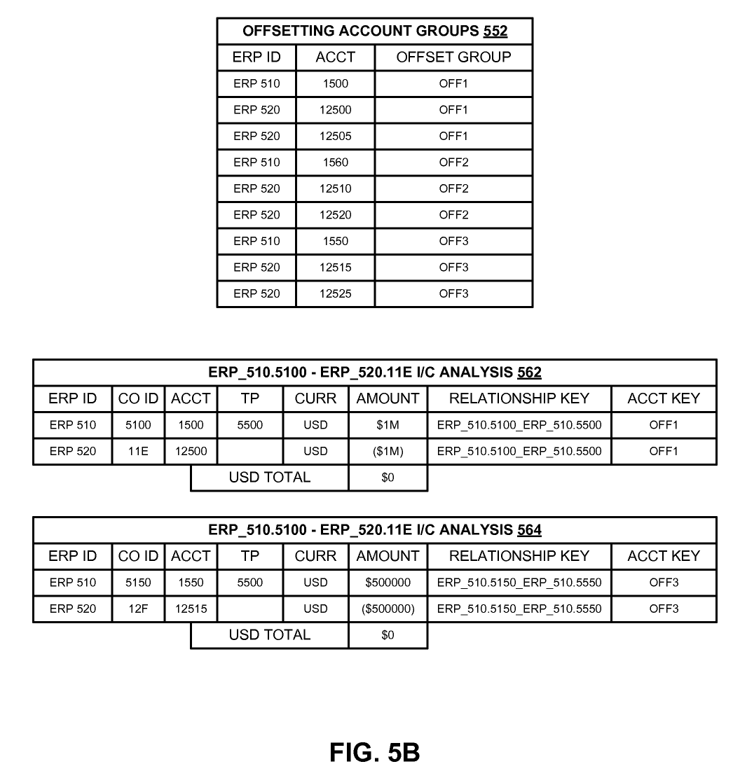

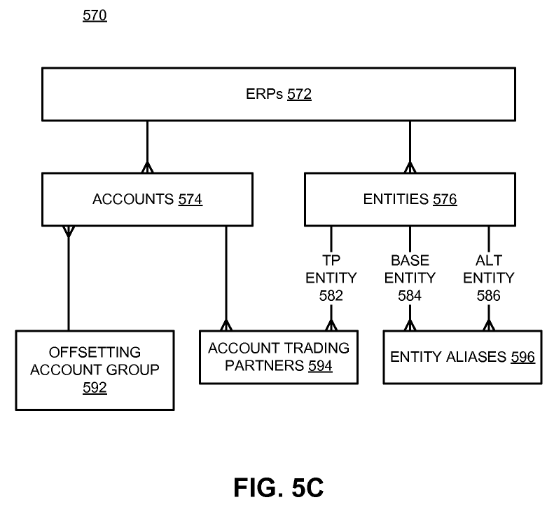

FIGS. 5A-5B illustrate an embodiment of example data used to group account balances by an I/C analyzer. ERP system 510 represents a first accounting system from which data will be obtained for I/C analysis. ERP system 520 represents the second accounting system from which data will be obtained. ERP system 510 includes entity 512, which indicates the entity designations for the entities associated with the accounting data in the system. In a real example, the number of entities could be dozens or more. Entities in ERP system 510 include ABC US 5100, ABC Canada 5150, ABC UK 5200, Digital AU (Australia) 5500, and Digital NZ (New Zealand) 5550. Note that ERP 510 is the home system for the “ABC” group of company entities, while ERP system 520 is the home system for the “Digital” group of company entities. Entities 522 for ERP system 520 are Digital AU 11E and Digital NZ 12F. Note that Digital AU 11E corresponds to Digital AU 5500 as the same entity, referenced by different systems. The relationships for Digital AU and Digital NZ are shown in entity aliases 546, which shows base entity 11E (i.e., the entity designation in the entity's home accounting system) of base ERP 520 (i.e., the home accounting system) having an alternate (alt) ERP of ERP 510 with an alternate entity designation of 5500. Similar data is shown for Digital NZ 12F.

ERP system 510 includes I/C account 514, which defines the intercompany accounts in the ERP system. Similar I/C account 524 of ERP system 520 defines the intercompany accounts of that accounting system. I/C account 514 includes accounts 1500 defined as I/C receivables and payables for US entities, 1550 defined as I/C receivables for countries other than the US, and 1560 defined as I/C payables for countries other than the US. Note that a different accounting convention is used in ERP system 520. I/C account 524 includes accounts 12500 defined as I/C receivables for ABC US (i.e., account 12500 is dedicated to posted receivables for transactions involving ABC US), 12505 defined as I/C payables for ABC US, 12510 defined as I/C receivables for ABC Canada, 12515 defined as I/C payables for ABC Canada, 12520 defined as I/C receivables for ABC UK, and 12525 defined as I/C payables for ABC UK. The account definitions are extracted from each ERP system, and stored within the I/C analysis system in account definitions 548, where the account definitions for each ERP are provided.

ERP system 510 includes transactions 516 defined by a key (5100.1500.5500) for 1 million USD. The transaction is understood as having the trading relationship (5100 and 5500), the currency (USD), and an account balance (1500). ERP system 520 indicates transaction 526 according to its accounting conventions. Transaction 526 indicates 11E.12500 for −1 million USD. Note that the transaction includes the currency (USD) and an account balance (12500). The trading relationship is not expressly provided in the transaction, because it is implicit in the accounting convention. That is, because of the account trading partner mapping, the trading relationship is known (account 12500 is for transactions with ABC US).

FIG. 5A further shows data generated and/or maintained by the I/C analysis system for I/C analysis. ERP table 542 indicates the accounting systems from which data is obtained. Entity table 544 indicates the entities associated with the transactions, and their associated ERP.

FIG. 5A also depicts account trading partner mappings 550. Mappings 550 include entries for accounts that indicate implicit entity relationships. Thus, with the mappings, the I/C analyzer will be able to extrapolate the entity relationship from the account data. Thus, the accounts of ERP 520 are shown, seeing that each I/C account 524 in ERP 520 implies a trading relationship. For example, account 12500 is shown as mapping to trading partner entity identifier 5100 of ERP 510. Thus, transactions in ERP system 520 that identify an entity of ERP system 520 and account 12500 can be mapped to the corresponding trading partner in ERP system 510.

FIG. 5B depicts offsetting account groups 552, which indicates groups of accounts that should net to zero. Thus, offset group OFF1 includes account 1500 of ERP system 510, and accounts 12500 and 12505 of ERP system 520. Thus, observe that all U.S. receivable and payable account balances as indicated in ERP system 510 (via account 1500) will be netted with all U.S. receivables (account 12500) and U.S. payables (account 12505) as indicated in ERP system 520. In this manner, all “like” accounts are mapped to a single offset group, which can be evaluated to determine if they net to zero. Similar relationships exist for offset group OFF2 with account 1560 of ERP system 510, and accounts 12510 and 12515 of ERP system 520, and offset group OFF3 associating account 1550 of ERP system 510, and accounts 12520 and 12525 of ERP system 520.

FIG. 5B also provides analyses 562 and 564. Analysis 562 is an analysis of I/C transactions between ERP system 510, entity 5100 and entity 11E of ERP system 520. The analysis sets out an example of how data may be organized, showing ERP ID, company ID, account number, trading partner (if not implied), currency, transaction amount, the relationship key used to extract that data, and the account key used to indicate the offset relationship. In this example, there is a match between the accounts and the amounts for the transaction, resulting in a USD total of $0, which is what is desired.

Similarly, analysis 564 is an analysis of I/C transactions between entity 5150 and entity 12F. A similar result is shown with offsetting positive and negative postings of $500,000 USD.

FIG. 5C is a block diagram of an embodiment of an account and entity organization tree. Organization tree 570 includes ERPs 572, which can have a one to many relationship between accounts 574 and entities 576. It will be understood that a one to many relationship refers herein to the concept that a single member of a first group is permitted to have relationships with multiple entities of a second group. Thus, a single ERP may have multiple accounts. Note that permission for relationships with multiple entities of another group does not guarantee any relationships. Thus, the member of the first group may have zero or more relationships with members of the other group.

Accounts 574 may have a many to one relationship with an offsetting account group 592, and a one to many relationship with account trading partners 594. Entities 576 may have a one to many relationship with account trading partners 594. Each such relationship represents a relationship as a trading partner (TP) entity 582. Entities 584 may have a one to many relationship with entity aliases 596. The same entity may be represented in different accounting/ERP systems under different numbering conventions. An entity may have a relationship with a base entity 584. That is, an entity could be involved in transactions with multiple entities that do not share the same home ERP system as the entity. An entity may have a relationship with an alternate entity 586. That is, an entity could be involved in transactions with multiple entities that have alternate designations in one or more other ERP systems.

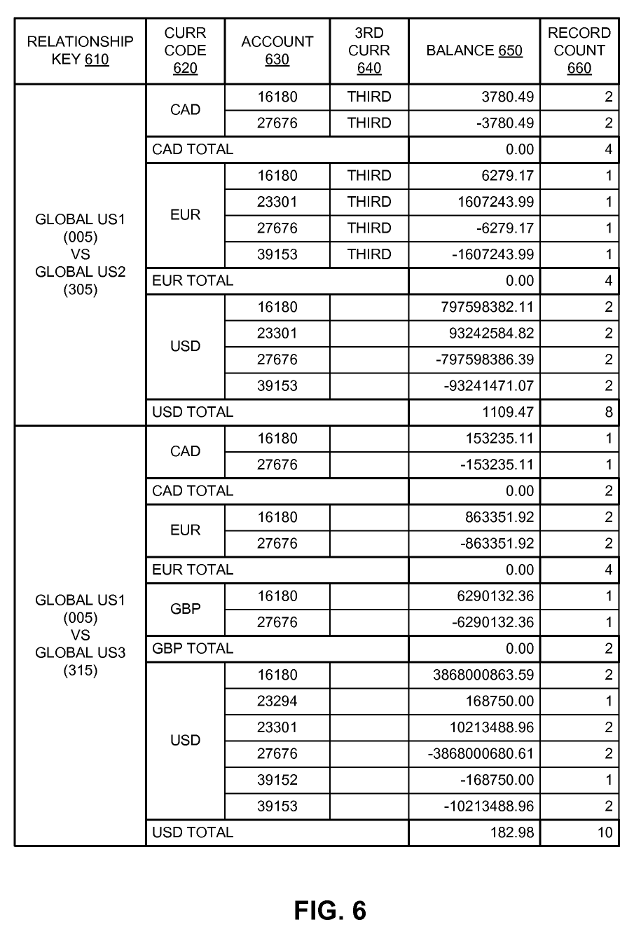

FIG. 6 illustrates an embodiment of example output data as provided by an I/C analyzer to group account balances based on entity and currency relationships. The data illustrated in FIG. 6 provides an example of results of processing with an I/C analyzer. While certain numbers are significant for the reasons provided below, the data values are artificial and intended as a general representation of how the data might be presented. Across the top of the figure are several columns or categories of data. Specifically shown are relationship key 610, currency (curr) code 620, account 630, third currency 640, balance 650, and record count 660.

Relationship key 610 provides the entity relationship. The top set of data corresponds to transactions between Global US1 and Global US2, which have respective entity identifiers of 005 and 305 in the general ledger data. The lower set of data corresponds to transactions between Global US1 (005) and Global US3 (315). The data for each entity relationship is gathered according to relationship key 610. Combined with currency code 620, there is a unique identifier to group data that can be evaluated for I/C issues. Global US1 and Global US2 have transactions in CAD (Canadian Dollar), EUR (Euro), and USD (U.S. Dollar). Note that in CAD, there are two records that make up account 16180 for a balance of +3780.49. There are two records that make up account 27676 for a balance of −3780.49. These two account balances offset one another for a CAD total of 0.00, which is what should be the case. Note that the account balances are third currency.

Like the CAD values, the EUR values indicate perfect offsetting, and an even count of records. Offsetting entries indicate a proper I/C convention is in place. I/C transactions are properly accounted for. However, note that for USD, the USD total is a non-zero value. There are not offsetting account balances in balance 650. While the zero balance net of the other currencies is exactly what is desired, the non-zero balance for USD indicates OOB condition with respect to those transactions.

With regard to the data indicating transactions between Global US 1 and Global US3, the top three currencies again each net to zero with offsetting balances, indicating proper accounting of the transactions. The currencies could net to zero without offsetting balances, which would seem to indicate that everything is accounted for, but would not necessarily give great confidence in the processes in place. The displaying of the data in the simple groups allows for more information to be conveyed to a user. Again there are problems with the accounting of the USD postings, which do not net to zero.

While not shown in the example of FIG. 6, if the total record count for a currency in the context of a relationship key is non-even, it would likely indicate a missing posting, or an error of some other type in the data. Where two records exist for an account (e.g., Global US1 vs. Global US3, EUR, accounts 16180 and 27676), the user would expect to find two postings to the account that total to the shown balance of 863351.92. For example, there might be two separate postings to the same account for 862,106.81 and 1245.11, with corresponding offsetting balances in the other account. Inconsistency in the counts can indicate that multiple I/C conventions are being mixed and matched, which should be investigated for consistency.

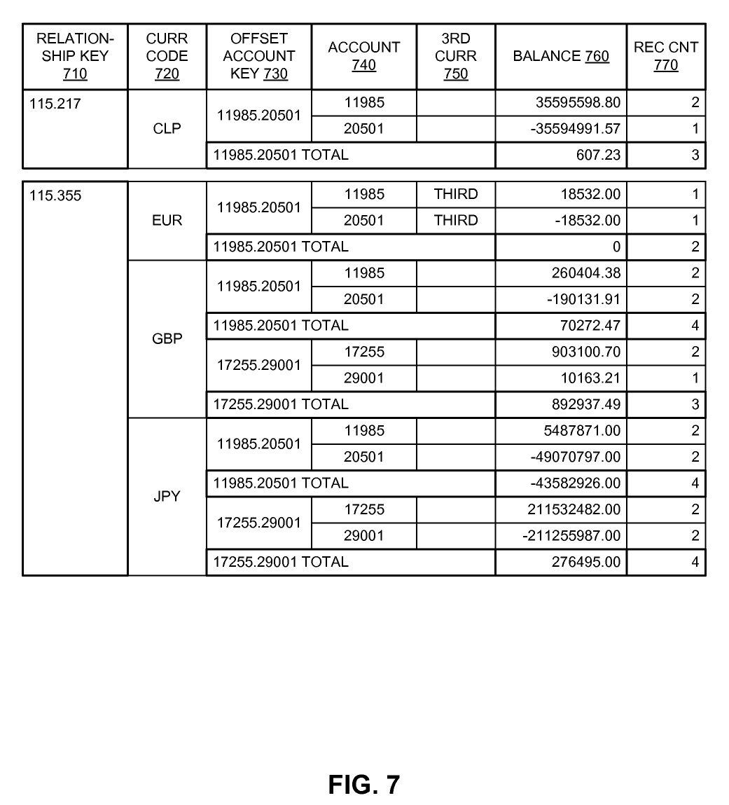

FIG. 7 illustrates an embodiment of example output data as provided by an I/C analyzer to group account balances based on entity, currency, and account relationships. The data illustrated in FIG. 7 provides an example of results of processing with an I/C analyzer. Similar to FIG. 6, while certain numbers are significant for the reasons provided below, the data values are artificial and intended as a general representation of how the data might be presented. Also similar to FIG. 6, while there is a great deal of example data provided for understanding in FIG. 7, not all data is explicitly explained in this description. The reader will be able to understand the data represented in the figure in light of what is described here.

Across the top of the figure are several columns or categories of data. Specifically shown are relationship key 710, currency (curr) code 720, offset account key 730, account 740, third currency 750, balance 760, and record count 770.

Relationship key 710 provides the entity relationship. Note that the form of the data will be different from implementation to implementation. FIG. 7 shows a different implementation than what is illustrated in FIG. 6. Specifically, the entity relationship is shown by relationship key 710 of a form entity1.entity2 (e.g., 115.217 and 115.355). For each currency for which accounting data exists for the two entities, data is provided. For currency CLP there is an offset key 730 of 11985.20501. The accounts that are identified by the offset key, accounts 11985 and 20501 in column account 740, are displayed. There are differing amounts (35,595,598.80 in 11985 and −35,594,991.57 in 20501) in balance 760, indicating an out of balance situation. Note that record count 770 indicates there are two records for account 11985, but only one for 20501. Thus, it would appear that a record is missing in account 20501, which may explain why there is a non-zero account balance.

For relationship key 115.355, there are three currency codes, EUR, GBP, and JPY, each of which includes one or more offset account keys 730. For EUR, accounts 11985 and 20501 should net to zero. The accounts have equal offsetting balances, and there is a net even number of records. Thus, the data for EUR appears to be in balance.

For GBP, accounts 11985 and 20501 should net to zero, and do not. There is a net even record count, but the value of the account balances demonstrates some error in the data. In one embodiment, the records can be drilled into by clicking on the record count. Then a different screen, a popup, or a different field could be brought up on the display with links to the underlying records themselves. Alternatively, the underlying records can be accessed and provided in the popup or different screen/view. Examining such “drill-down” data may inform a user as to a reason for the non-zero balance, or at least indicate where to start looking for a data discrepancy. Errors similarly exist for accounts 17255 and 29001, where a non-zero balance is shown, as well as an odd net record count.

For JPY, the same offset account keys, 11985.20501 and 17255.29001 are applied to the entity-currency relationship key as with the entity-currency relationship key for GBP. The results of such a data search also indicate incorrect postings resulting in non-zero balances for the offsetting account keys. Such information can indicate to a user that the offsetting accounts are not being properly posted to.

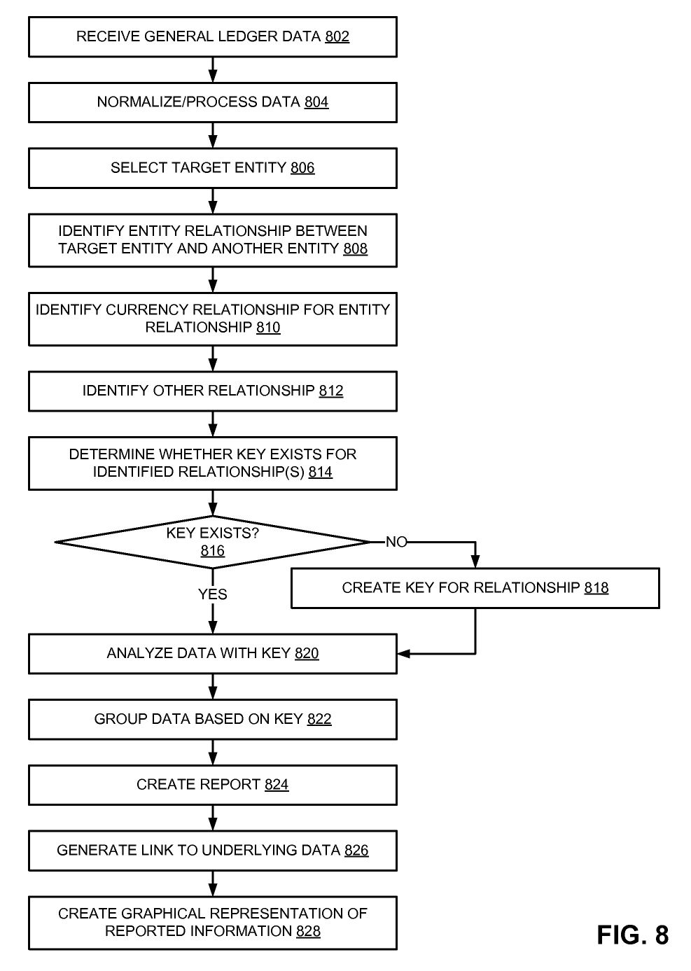

FIG. 8 is a flow diagram of an embodiment of a process for intercompany analysis of accounting data. Flow diagrams as illustrated herein provide examples of sequences of various process actions. Although shown in a particular sequence or order, unless otherwise specified, the order of the actions can be modified. Thus, the illustrated implementations should be understood only as an example, and the process for establishing the secure channel can be performed in a different order, and some actions may be performed in parallel. Additionally, one or more actions can be omitted in various embodiments of the invention; thus, not all actions are required in every implementation. Other process flows are possible.

A data workbench receives general ledger data related to transactions between business entities belonging to the same corporate enterprise, 802. Note that a complete I/C analysis would require all accounting data related to intercompany transactions. Lesser amounts of the data will result in less complete analyses. The data workbench may normalize some or all of the received accounting or G/L data, 804. In one embodiment, the data workbench includes an I/C analyzer, which begins processing by selecting a target business entity, 806.

The I/C analyzer identifies an entity relationship between the target entity and another business entity, 808. Such a relationship can be identified, for example, by searching for account balances where the target entity is one of the parties to the transaction. The transaction can then be considered one of a set of one or more transactions with the entity relationship. The I/C analyzer also identifies from the data what currency relationship exists for the entity relationship, 810. Other records may be found that indicate other currency relationships for the entity relationship. In one embodiment, one or more other relationships may be identified, 812. Examples of other such relationships include account-based relationships such as offset groups or groupings based on account relationships related to entities, accounts, or systems.

In one embodiment, for each key or each relationship, the I/C analyzer determines whether a key or unique identifier exists for the entity/currency/other relationship, 814. If the key does not exist, 816, the I/C analyzer creates the key for the identified relationships, 818. If the key exists, 816, or after creating the key, 818, the I/C analyzer analyzes the G/L data with the key, 820. Analyzing the data with the key will enable the I/C analyzer to extract data related by the elements (e.g., the entity relationship, currency relationship, account relationship, etc.) of the key. The I/C analyzer then groups the data based on the key, 822. Such a process of identifying relationships and keys can be repeated for various relationships and keys and the data processed multiple times under the “filter” of different keys.

The I/C analyzer creates one or more reports to indicate what has been determined by processing the data, 824. The reports can indicate abnormalities or potential abnormalities. In one embodiment, the I/C analyzer generates a link from a report to the underlying data, 826. In one embodiment, the I/C analyzer creates a graphical representation of the reported information, 828.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A computer implemented method for accounting data management comprising:
receiving general ledger data defining intercompany account balances for an enterprise having multiple business entities;
grouping account balances from the general ledger data according to a currency relationship and a trading relationship between two business entities of the enterprise; and
creating a report to indicate the grouped account balances.

2. The method of claim 1, wherein receiving the general ledger data comprises:
receiving data from multiple separate accounting systems.

3. The method of claim 1, wherein grouping the account balances according to the currency relationship and the trading relationship further comprises:
creating a unique identifier identifying the currency relationship and the two business entities; and
searching the general ledger data for account balances that match the elements of the unique identifier.

4. The method of claim 3, wherein creating the unique identifier comprises:
identifying a trading relationship with a currency relationship from an intercompany account balance of the general ledger data;
determining that a unique identifier does not exist for the trading relationship with the currency relationship; and
generating a new unique identifier for the trading relationship with the currency relationship.

5. The method of claim 3, wherein creating the unique identifier comprises:
identifying all trading relationships for all combinations of two business entities and currency relationships from the general ledger data;
creating unique identifiers for every combination of trading relationship and currency relationship identified from the general ledger data;
selecting an intercompany account balance of the general ledger data; and
generating a mapping between the selected intercompany account balance and a unique identifier corresponding to a trading relationship and currency relationship indicated in the intercompany account balance.

6. The method of claim 3, wherein creating the unique identifier comprises:
creating the unique identifier in accordance with a hierarchical ordering of business entities.

7. The method of claim 1, wherein grouping the account balances further comprises:
creating a unique identifier identifying an account relationship among account balances in addition to the currency relationship and trading relationship; and
searching the general ledger data for account balances that match the elements of the unique identifier identifying the account relationship.

8. The method of claim 7, wherein creating the unique identifier identifying the account relationship comprises:
creating a unique identifier to indicate accounts related on the basis of a trading relationship, an account relationship, or a system relationship.

9. The method of claim 8, wherein creating the unique identifier to indicate accounts related on the basis of trading relationship comprises:
creating a unique identifier to indicate accounts related according to business unit, region, project code, or profit center designation.

10. The method of claim 8, wherein creating the unique identifier to indicate accounts related on the basis of account relationship comprises:
creating a unique identifier to indicate accounts related according to project code, account number, subaccount number, or cost center designation.

11. The method of claim 8, wherein creating the unique identifier to indicate accounts related on the basis of system relationship comprises:
creating a unique identifier to indicate accounts related according to data source or user.

12. The method of claim 1, wherein creating the report to indicate the grouped account balances comprises:
identifying a potential out-of-balance situation in the general ledger data; and
generating a flag to indicate the potential out-of-balance situation.

13. The method of claim 12, wherein identifying the potential out-of-balance situation comprises:
indicating a non-zero trading balance.

14. The method of claim 12, wherein identifying the potential out-of-balance situation comprises:
identifying a number of records constituting the grouped account balances; and
indicating a non-even record count.

15. The method of claim 1, wherein creating the report to indicate the grouped account balances comprises:
indicating an error condition based on one or more of
a third currency in a trading relationship; or
a trading relationship where the same business entity exists on both sides of the trading relationship.

16. The method of claim 1, wherein creating the report comprises:
generating a graphical representation of the underlying relationships of the grouped account balances.

17. The method of claim 16, wherein generating the graphical representation of the underlying relationships of the grouped account balances comprises:
generating a graphical representation based on one or more of the trading relationships or the currency relationships.

18. The method of claim 16, wherein generating the graphical representation of the underlying relationships of the grouped account balances further comprises:
applying filters to the grouped account balances to produce a reduced data set to be graphically represented.

19. The method of claim 1, wherein creating the report to indicate the grouped account balances further comprises:
generating active or inactive links within the report to enable access from the report to specific entries in the general ledger data corresponding to information in the report.

20. An article of manufacture comprising a machine readable medium having content stored thereon to provide instructions to cause a machine to perform operations including:
receiving general ledger data defining intercompany account balances for an enterprise having multiple business entities;
grouping account balances from the general ledger data according to a currency relationship and a trading relationship between two business entities of the enterprise; and
creating a report to indicate the grouped account balances.

21. The article of manufacture of claim 20, wherein the content to provide instructions for grouping the account balances according to the currency relationship and the trading relationship further comprises content to provide instructions for identifying a trading relationship with a currency relationship from an intercompany account balance of the general ledger data;
determining that a unique identifier does not exist for the trading relationship with the currency relationship; and
generating a new unique identifier for the trading relationship with the currency relationship; and
searching the general ledger data for account balances that match the elements of the unique identifier.

22. The article of manufacture of claim 20, wherein the content to provide instructions for creating the report to indicate the grouped account balances comprises content to provide instructions for
identifying a potential out-of-balance situation or error condition in the general ledger data; and
generating a flag to indicate the potential out-of-balance situation or error condition.

23. The article of manufacture of claim 20, wherein the content to provide instructions for creating the report comprises content to provide instructions for
generating a graphical representation of the underlying relationships of the grouped account balances.

24. A method comprising:
accessing a communication interface; and
providing a data signal on the communication interface having data describing:
a data collection module to obtain general ledger data defining intercompany account balances for an enterprise having multiple business entities;
a key generator to generate a unique identifier based on a trading relationship and a currency relationship for two business entities of the enterprise;
an analysis engine to group account balances from the general ledger data according to the trading relationship and the currency relationship of the key; and
a report generator to generate a report indicating the grouped account balances.

25. The method of claim 24, wherein the signal has further data describing:
the key generator to generate a unique identifier based on the trading relationship, the currency relationship, and at least one other account relationship indicating a commonality among account balances.

26. The method of claim 24, wherein the signal has further data describing:
the analysis engine having a data aggregator including an identity filter and a currency filter to be hierarchically applied to the general ledger data to associate to a selected business entity general ledger data related to transactions of the selected business entity with another business entity in one or more currencies.

27. The method of claim 24, wherein the signal has further data describing:
the report generator to generate a flag to indicate one or more of
a third currency in a trading relationship;
a trading relationship where the same business entity exists on both sides of the trading relationship; or
a non-zero trading balance.

28. The method of claim 24, wherein the signal has further data describing:
a data linker to generate active or inactive links from the report indicating the grouped account balances to underlying general ledger data from which information in the report is derived.

29. A method comprising:
accessing a communication interface; and
providing a data signal on the communication interface having data describing:
a data collection module to obtain general ledger data defining asset and liability account balances for an enterprise having multiple business entities, the asset and liability account balances including intercompany account balances;
an intercompany analysis tool including:
a key generator to generate a unique identifier based on a trading relationship and a currency relationship for two business entities of the enterprise;
an analysis engine to group account balances from the general ledger data according to the trading relationship and the currency relationship of the key; and
a report generator to generate a report indicating the grouped account balances; and
a foreign exchange analysis tool including:
a functional currency filter module to filter account balances from the general ledger data where the transactional currency and the functional currency of the business entity are the same, to produce a data grouping of non-functional currency account balances;
a revaluation filter module to filter account balances from the data grouping of non-functional currency account balances that are not subject to revaluation, to produce a data grouping of revalued account balances;
an exclusion filter module to filter account balances to exclude from analysis, for example, data with known issues or data that is known to need special handling; and
a report generator to generate a report indicating the revalued account balances.

30. The method of claim 29, wherein the signal has further data describing:
a currency exchange risk management module to process the data grouping to indicate potential currency exchange risk based on the account balances.
